(19) United States
(12) Patent Application Publication
(10) Pub. No.: US 2014/0163836 A1
(43) Pub. Date: Jun. 12, 2014

(54) Apparatus and method for automatically controlling the speed of a vehicle in a speed bump area

(71) Applicant: Hyundai Motor Company, Seoul (KR)

(72) Inventors: Dae Youn Um, Gyeonggi-do (KR); Jee Young Kim, Gyeonggi-do (KR)

(21) Appl. No.: 13/815,976

(22) Filed: Mar. 18, 2013

(30) Foreign Application Priority Data
Dec. 7, 2012 (KR) 20120142056

(51) Int. Cl. B60K 31/00

(52) U.S. Cl. CPC B60K 31/00
USPC 701/93; 701/70

(57) ABSTRACT

The speed of a vehicle is automatically controlled in a speed bump area located in the vicinity of a speed bump. Information about a speed bump is received from a navigation device, and a distance between the vehicle and the speed bump is calculated. If the calculated is less than a preset reference distance, it is determined that the vehicle is entering or has entered an area of the speed bump. Upon determining that the vehicle is in the speed bump area, a speed difference between a safe speed bump crossing speed and a current speed of the vehicle is computed, a required acceleration value is calculated based on the calculated distance to the speed bump and the speed difference, and the speed of the vehicle is controlled so that the vehicle decelerates or accelerates in accordance with the required acceleration value.

### CROSS-REFERENCE TO RELATED APPLICATION

This application claims the benefit under 35 U.S.C. §119(a) of Korean Patent Application No. 10-2012-0142056, filed Dec. 7, 2012, the entire contents of which are incorporated herein by reference.

### BACKGROUND OF THE INVENTION

1. Field of the Invention

The present invention relates, in general, to automatic speed control technology for vehicles and, more particularly, to a method and apparatus for automatically controlling speed in the vicinity of a speed bump. The method and apparatus can, for example, automatically control the speed of a vehicle so that the vehicle accelerates or decelerates in the speed bump area by combining speed bump information input from a navigation device with an automatic speed control system.

2. Description of the Related Art

A smart cruise control system denotes a system for performing speed control so that the speed of one vehicle is maintained at the speed set by a driver when there is no preceding vehicle ahead of the one vehicle, and performing distance control so that a distance from the preceding vehicle is maintained to at least a predetermined distance when the preceding vehicle is present, thus providing convenience and safety to the driver of the one vehicle without the driver having to manually manipulate a brake, an accelerator, or the like.

Meanwhile, a conventional smart cruise control system controls a traveling speed to conform with the speed limit of each road by receiving driving information in a wireless manner via a navigation device, thus not only preventing a vehicle from driving over the speed limit, but also providing excellent driving convenience to a driver.

However, since such a conventional smart cruise control system cannot recognize a speed bump even if the speed bump is present in front of the corresponding vehicle, speed control is not adequately conducted in a speed bump area.

That is, in order to automatically control the speed of a vehicle using the smart cruise control system, a front impact sensor, such as a radar, is used. A radar applied to a vehicle generally does not distinguish between a speed bump and the ground of the roadway. Therefore, the use of radar is problematic as it cannot recognize a speed bump and thus cannot automatically perform speed control (automatic cruise control) in response to detecting a speed bump.

Further, when a camera is used instead of radar, a speed bump can be recognized only when the color of the speed bump is different from the color of the surrounding roadway. In particular, the use of a camera is problematic in that if only the shape of a speed bump is drawn in a predetermined color on the roadway (without a speed bump actually being present on the roadway), the camera generally identifies a speed bump as being present and thus erroneously initiates an automatic speed control operation.

Meanwhile, Korean Patent Application Publication No. 10-2012-0119424 discloses technology entitled “Automatic cruise control system and method.” However, the technology disclosed in the publication cannot automatically control the speed of a vehicle in response to a speed bump.

The foregoing is intended merely to aid in the better understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the prior art, and an object of the present invention is to provide a method and apparatus for automatically controlling the speed of a vehicle in the vicinity of a speed bump so that the vehicle accelerates or decelerates in a speed bump area based on speed bump information input from a navigation device and using an automatic speed control system.

In order to accomplish the above object, the present invention provides a method of automatically controlling speed of a vehicle in a vicinity of a speed bump, including a) receiving, in a control unit coupled to a cruise control system of a vehicle, information about a speed bump from a navigation device and calculating a distance between the vehicle and the speed bump; b) upon determining that the calculated distance between the vehicle and the speed bump is less than a preset reference distance, determining that the vehicle is entering of has entered an area of the speed bump; and c) upon determining that the vehicle is entering or has entered the speed bump area, computing a speed difference between a safe speed bump crossing speed set to allow the vehicle to safely drive across the speed bump and a current speed of the vehicle, and calculating a required acceleration based on the calculated distance between the vehicle and the speed bump and on the computed speed difference; and d) controlling the speed of the vehicle so that the vehicle decelerates or accelerates in accordance with the calculated required acceleration value.

In one example, step c) includes c1) measuring a variation in height of a front wheel suspension of the vehicle with respect to a vertical direction of the front wheel suspension; c2) upon determining that the measured height variation is greater than a preset reference height variation, determining that the corresponding vehicle is currently crossing the speed bump and controlling the speed of the vehicle so that the speed is maintained at a constant speed.

In another example, step c) includes, upon determining that a speed difference obtained by subtracting the current speed of the vehicle from the safe speed bump crossing speed is less than 0, calculating the required acceleration value according to the equation: required acceleration value=−speed difference²/(2×distance between corresponding vehicle and speed bump).

In another example, step c) includes, upon determining that a speed difference obtained by subtracting the speed of the vehicle from the safe speed bump crossing speed is greater than 0, setting a maximum acceleration value for the vehicle to a predetermined value and controlling the speed of the vehicle through acceleration or deceleration at no more than the set maximum acceleration value.

In another example, step c) includes measuring a variation in height of a rear wheel suspension of the vehicle with respect to a vertical direction of the rear wheel suspension, and upon determining that the measured height variation is greater than a preset reference height variation, determining that the corresponding vehicle has crossed the speed bump and releasing deceleration controls imposed on the vehicle.

Further, the present invention provides an apparatus for automatically controlling speed of a vehicle in a vicinity of a speed bump, the apparatus including a speed bump information calculation unit for receiving information about a speed bump from a navigation device and calculating a distance between the vehicle and the speed bump; a speed bump area determination unit for determining that the distance between the vehicle and the speed bump is less than a preset reference distance, and upon making the determination, further determining that the corresponding vehicle is entering or has entered an area of the speed bump located within a vicinity of the speed bump; a vehicle speed control unit for, upon determining that the vehicle is entering or has entered the speed bump area, computing a speed difference between a safe speed bump crossing speed set to allow the vehicle to safely cross the speed bump and a current speed of the vehicle, calculating a required acceleration value based on the calculated distance between the vehicle and the speed bump and on the computed speed difference, and controlling the speed of the vehicle in accordance with the calculated required acceleration value.

In addition, the present invention provides an apparatus for automatically controlling speed of a vehicle in a vicinity of a speed bump, including a control unit configured to receive information about a speed bump from a navigation device and calculate a distance between the vehicle and the speed bump, and upon determining that the calculated distance between the vehicle and the speed bump is less than a preset reference distance, determine that the vehicle is entering or has entered an area of the speed bump located within the vicinity of the speed bump, upon determining that the vehicle is entering or has entered the speed bump area, compute a speed difference between a safe speed bump crossing speed set to allow the vehicle to safely cross the speed bump and a current speed of the vehicle, calculate a required acceleration value based on the calculated distance between the vehicle and the speed bump and on the computed speed difference, and control the speed of the vehicle in accordance with the calculated required acceleration value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing a vehicle having its speed automatically controlled as the vehicle travels through a speed bump area according to the present invention;

FIG. 2 is a diagram showing an apparatus for automatically controlling speed in a speed bump area according to the present invention; and

FIG. 3 is a flowchart showing the control flow of a method of automatically controlling speed in a speed bump area according to the present invention.

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

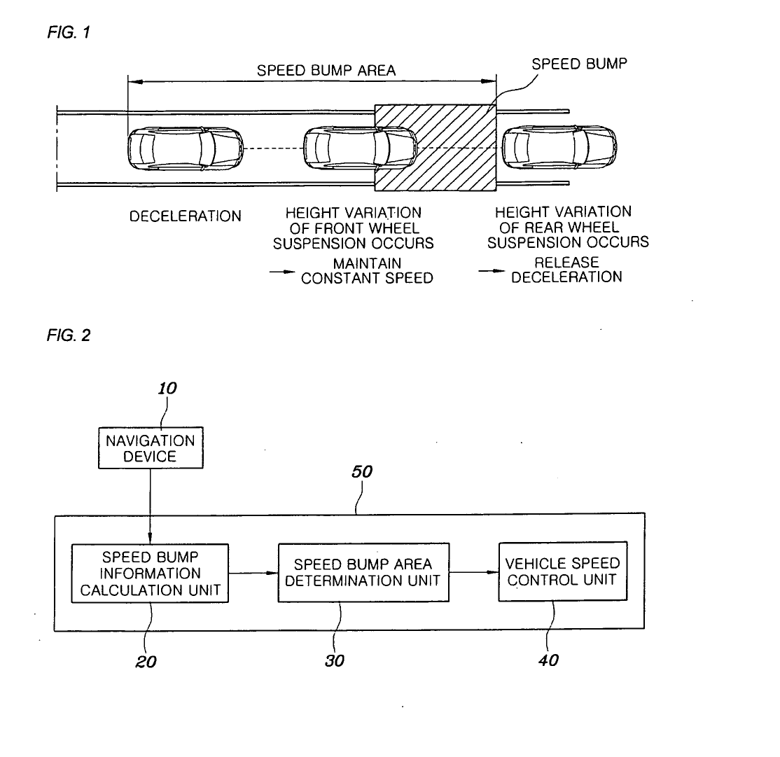

FIG. 1 is a diagram schematically showing a vehicle having its speed automatically controlled as the vehicle travels through a speed bump area according to the present invention, and FIG. 2 is a diagram showing an apparatus for automatically controlling speed in a speed bump area according to the present invention.

The method and apparatus for automatically controlling speed in a speed bump area according to the present invention are configured to allow a smart cruise control system to automatically control the speed of a vehicle in a speed bump area located in front of the corresponding vehicle. The method and apparatus rely at least in part on road information obtained by a navigation device 10, such as information about a speed bump, that is provided to the smart cruise control system.

Referring to FIGS. 1 and 2, the apparatus for automatically controlling speed in a speed bump area according to the present invention may be configured to include a speed bump information calculation unit 20, a speed bump area determination unit 30, and a vehicle speed control unit 40.

In detail, the speed bump information calculation unit 20 is configured to receive information about each speed bump from the navigation device 10 and to calculate a distance between the vehicle and the speed bump. The speed bump area determination unit 30 is configured to, if the calculated distance between the vehicle and the speed bump is less than a preset reference distance, determine that the vehicle is entering or has entered the area of the speed bump. The vehicle speed control unit 40 is configured to, if it is determined that the vehicle is entering or has entered the speed bump area, compute a speed difference between a safe speed bump crossing speed set to allow the vehicle to safely and comfortably cross the speed bump and the actual/current speed of the vehicle. The vehicle speed control unit 40 is further configured to calculate a resulting required acceleration or deceleration value based on the calculated distance to the speed bump and the computed speed difference, which can be used to control the speed of the vehicle.

In general, the speed bump information calculation unit 20 receives information about each speed bump from the navigation device 10. The received information preferably includes location information for the speed bump. The speed bump information calculation unit 20 then calculates a distance between the vehicle and the speed bump.

The speed bump area determination unit 30 is configured to, if the calculated distance between the vehicle and the speed bump is less than the preset reference distance, determine that the corresponding vehicle is entering or has entered the speed bump area. The term “reference distance” generally denotes a predetermined distance which was previously stored in the speed bump area determination unit 30, and which can be set to a suitable distance by a driver and/or vehicle manufacturer to control the acceleration or deceleration of the vehicle so that the vehicle can safely and comfortably cross the speed bump.

The vehicle speed control unit 40 is configured to, if it is determined that the corresponding vehicle is entering or has entered the speed bump area, compute the speed difference between the safe speed bump crossing speed set to allow the vehicle to safely and comfortably cross the speed bump and the actual/current speed of the vehicle. Further, the vehicle speed control unit 40 calculates the required acceleration or deceleration value based on the calculated distance to the speed bump and the computed speed difference, so as to control the speed of the vehicle using the required acceleration or deceleration value.

The term “safe speed bump crossing speed” can denote a predetermined speed value which was previously stored in the vehicle speed control unit 40, and which can be set to a suitable speed at which the vehicle can safely and comfortably cross the speed bump without damaging a vehicle body or causing discomfort to a driver or passengers of the vehicle. In some example, the “safe speed bump crossing speed” can denote a speed value retrieved from the navigation device 10 and indicative of a speed rating associated with the speed bump or roadway the vehicle is travelling on.

The vehicle speed control unit 40 calculates the distance to the speed bump using the navigation device 10 to determine whether the corresponding vehicle is entering or has entered the speed bump area. The vehicle speed control unit 40 further calculates the required acceleration or deceleration value of the vehicle based on the speed difference value if the vehicle is entering or has entered the speed bump area, so as to suitably control the speed of the vehicle. As a result, the vehicle accelerates or decelerates in response to the specific required acceleration or deceleration value calculated based on the current/actual speed of the vehicle as it enters the speed bump area. Therefore, the speed of the vehicle crossing the speed bump is automatically controlled such that the intervention of the driver is not required to manually control the speed of the vehicle in response to the speed bump, thus improving driving convenience.

Furthermore, the apparatus for automatically controlling speed in a speed bump area according to the present invention may be configured such that the components of the speed bump information calculation unit 20, the speed bump area determination unit 30, and the vehicle speed control unit 40 are integrated into a control unit 50, thus enabling the speed of the vehicle in a speed bump area to be automatically controlled by the control unit 50 coupled to the vehicle's cruise control system.

In detail, the apparatus for automatically controlling speed in a speed bump area may be configured to include the control unit 50 for receiving information about each speed bump through the navigation device 10, calculating a distance between the corresponding vehicle and the speed bump, determining that the corresponding vehicle is entering or has entered the speed bump area if the calculated distance between the corresponding vehicle and the speed bump is less than a preset reference distance, computing a speed difference between the safe speed bump crossing speed set to allow the vehicle to safely and comfortably cross the speed bump and the current/actual speed of the corresponding vehicle if it is determined that the corresponding vehicle is entering or has entered the speed bump area, and calculating a required acceleration or deceleration value based on the calculated distance to the speed bump and the computed speed difference, so as to control the speed of the vehicle in response to the required acceleration or deceleration value.

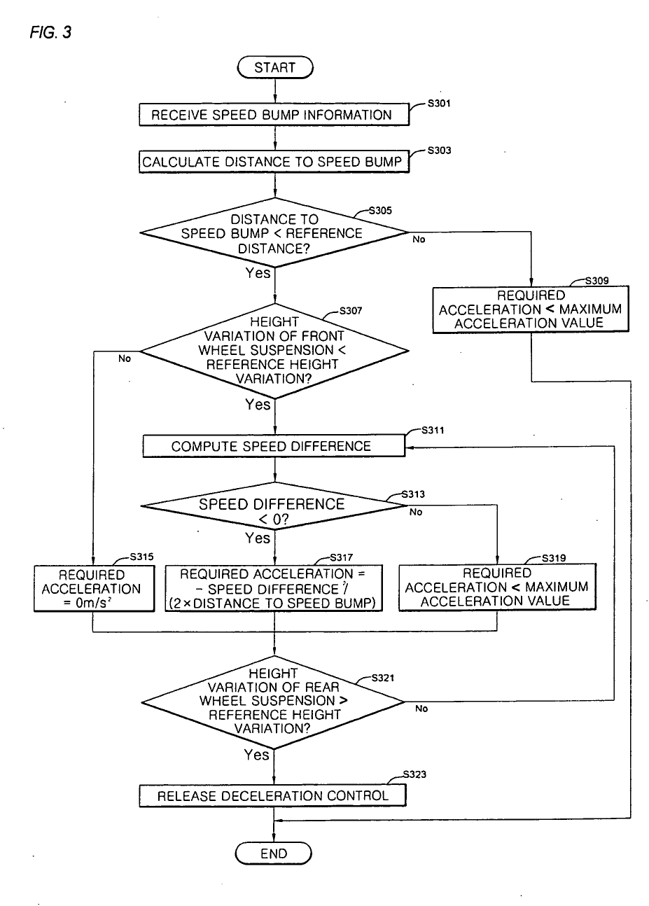

FIG. 3 is a flowchart showing the control flow of a method of automatically controlling speed in a speed bump area according to the present invention.

Referring to FIG. 3, a method of automatically controlling speed in a speed bump area according to the present invention includes a step for obtaining speed bump information, a speed bump area determination step, and a vehicle speed control step. The step for obtaining speed bump information includes steps for receiving information about each speed bump via the navigation device 10 (step S301) and for calculating a distance between the corresponding vehicle and the speed bump(s) (step S303). The speed bump area determination step includes steps of, if the calculated distance between the vehicle and the speed bump is less than a reference distance (in step S305), determining that the corresponding vehicle is entering or has entered the area of a speed bump. The vehicle speed control step includes steps of, if it is determined that the vehicle is entering or has entered the speed bump area, computing a speed difference between a safe speed bump crossing speed set to allow the vehicle to safely and comfortably cross the speed bump and the current/actual speed of the vehicle (step S311), and calculating a required acceleration or deceleration value based on the calculated distance to the speed bump and the computed speed difference (steps S313, S317, and S319), to thereby control the speed of the vehicle such that the vehicle decelerates or accelerates according to the calculated required acceleration or deceleration value.

In detail, at the step for obtaining speed bump information, the location information of the speed bump is received from the navigation device 10 in step S301, and a distance between the vehicle and the speed bump is calculated in step S303.

Further, as part of the speed bump area determination step, if the calculated distance in step S305 between the vehicle and the speed bump is less than a preset reference distance (step S305, “Yes”), it is determined that the corresponding vehicle is entering or has entered the speed bump area, and the speed of the vehicle is automatically controlled so that the vehicle accelerates or decelerates as the vehicle travels through the speed bump area during the vehicle speed control step (including steps S311, S313, S317, and S319). In contrast, if the distance between the vehicle and the speed bump is calculated as a distance equal to or greater than the preset reference distance (step S305, “No”), it is determined that the vehicle is located outside of the speed bump area and the speed of the vehicle is automatically controlled by the speed control system without consideration of the speed bump by controlling an acceleration value within the range of a maximum acceleration value set in the vehicle (step S309).

The maximum acceleration value can be set as an acceleration value of 10 m/s² or to another appropriate acceleration value. The vehicle can generally travel while the speed of the vehicle is automatically controlled through acceleration or deceleration at no more than the maximum acceleration value.

Furthermore, as part of the vehicle speed control step, if it is determined that the vehicle is entering or has entered the speed bump area (step S305, “Yes”), the speed difference between the safe speed bump crossing speed set to allow the vehicle to safely and comfortably drive across the speed bump and the present/actual speed of the vehicle is computed in step S311. A required acceleration value is also calculated based on the calculated distance to the speed bump and the computed speed difference in step S317, to thereby control the speed of the vehicle so that the vehicle decelerates or accelerates in response to the calculated required acceleration value.

Additional detailed information relating to the control flow is provided below. A variation in the height of the front wheel suspension of the vehicle with respect to the vertical direction of the front wheel suspension can be measured in step S307. If the measured height variation is greater than a preset reference height variation, it is determined that the vehicle is currently crossing the speed bump and the speed of the vehicle is controlled so that it is maintained at a constant speed in step S315 (e.g., a required acceleration of 0 m/s² is set). In this case, the preset reference height variation with respect to the vertical direction of the front wheel suspension can be predetermined reference height variation previously stored in the vehicle speed control unit 40. The measurement of the height variation can be performed by measuring a variation in the length of a shock absorber, or by utilizing other various measurement methods.

Meanwhile, when the measured height variation of the front wheel suspension of the vehicle in the vertical direction is less than a preset reference height variation, the vehicle is determined not to be crossing the speed bump yet. Accordingly, until the vehicle reaches the speed bump, the process proceeds to lower-step logic for calculating the required acceleration value of the vehicle and controlling the vehicle speed so that the vehicle accelerates or decelerates in accordance with step S311 and the subsequent steps.

After having computed the speed difference between the safe speed bump crossing speed and the vehicle's current/actual speed in step S311, if the speed difference obtained by subtracting the speed of the vehicle from the safe speed bump crossing speed is less than 0 (as determined in step S313), the required acceleration value is calculated by the following Equation (1) in step S317 such that the vehicle speed can be controlled according to the required acceleration value.

The safe speed bump crossing speed can be a predetermined value that is previously stored in the vehicle speed control unit 40, and can be set to a speed at which the vehicle can safely and comfortably cross the speed bump.

Further, Equation (1) can be given by:

required acceleration value=−speed difference²/(2×distance between corresponding vehicle and speed bump)

In particular in step S317, the speed difference being less than 0 indicates that the speed of the vehicle is greater than the safe speed bump crossing speed. Hence, the speed of the vehicle entering the speed bump area is controlled so that the vehicle decelerates according to equation (1).

In contrast, if the speed difference obtained by subtracting the speed of the vehicle from the safe speed bump crossing speed is greater than 0 (as determined in step S313), the speed of the vehicle is controlled in step S319 by the speed control system by controlling an acceleration value within the range of the maximum acceleration value (i.e., by setting an acceleration or deceleration value no greater in amplitude than the maximum acceleration value).

In particular in step S319, the speed difference being greater than 0 means that the speed of the vehicle is less than the safe speed bump crossing speed. Accordingly, the speed of the vehicle entering the speed bump area is preferably controlled such that the vehicle accelerates no faster than the safe speed bump crossing speed.

In addition, the method may be configured to further include a speed bump area deviation determination step for measuring a variation in height of the rear wheel suspension of the vehicle with respect to the vertical direction of the rear wheel suspension in step S321, and if the measured height variation is greater than the preset reference height variation, determining that the corresponding vehicle has crossed the speed bump and thus releasing the deceleration control of the vehicle in step S323.

That is, in order to solve a phenomenon in which deceleration is not released even after the vehicle has crossed the speed bump due to inaccuracies in the calculation of a distance to a speed bump (such as inaccuracies attributable to errors in a Global Positioning System (GPS) measurement and/or in a map), the height variation of the rear wheel suspension of the vehicle is monitored in step S321. If the height variation becomes greater than the reference height variation, it is determined that the rear wheels of the corresponding vehicle have crossed the speed bump, and the logic control causing the vehicle to decelerate so as to cross the speed bump safely is released in step S323. Conversely, if the height variation remains smaller than the reference height variation (step S321, “No”), it is determined that the rear wheels of the corresponding vehicle have not crossed the speed bump and the deceleration control remains in effect.

In this way, the present invention calculates a distance from a vehicle to a speed bump using the navigation device 10, determines that the vehicle enters the speed bump area, and calculates the required acceleration value of the vehicle as different values based on a speed difference measured when the vehicle enters the speed bump area, so as to suitably control the speed of the vehicle such that the vehicle accelerates or decelerates in response to a required acceleration value calculated based at least in part on the speed of the vehicle that has entered the speed bump area. Therefore, the present invention can automatically control the speed of the vehicle that crosses the speed bump, and can then improve driving convenience by omitting the driver's intervention required to control the speed of the vehicle while driving across a speed bump.

The present invention is advantageous in that the location of a speed bump is detected using a navigation device, and the speed of a vehicle crossing the speed bump is automatically controlled in the vicinity of the speed bump by a smart cruise control system, thus improving driving convenience by obviating the driver's intervention as is generally required to control the speed of the vehicle when driving across speed bumps.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of automatically controlling speed of a vehicle in the vicinity of a speed bump, comprising steps of:
a) receiving, in a control unit coupled to a cruise control system of a vehicle, information about a speed bump from a navigation device and calculating a distance between the vehicle and the speed bump;
b) upon determining that the calculated distance between the vehicle and the speed bump is less than a preset reference distance, determining that the vehicle is entering or has entered an area of the speed bump;
c) upon determining that the vehicle is entering or has entered the speed bump area, computing a speed difference between a safe speed bump crossing speed set to allow the vehicle to safely drive across the speed bump and a current speed of the vehicle, and calculating a required acceleration value based on the calculated distance between the vehicle and the speed bump and on the computed speed difference; and
d) controlling the speed of the vehicle so that the vehicle decelerates or accelerates in accordance with the calculated required acceleration value.

2. The method of claim 1, wherein step c) further comprises:
c1) measuring a variation in height of a front wheel suspension of the vehicle with respect to a vertical direction of the front wheel suspension;
2) upon determining that the measured height variation is greater than a preset reference height variation, determining that the corresponding vehicle is currently crossing the speed bump and controlling the speed of the vehicle so that the speed is maintained at a constant speed.

3. The method of claim 1, wherein step c) comprises:
upon determining that a speed difference obtained by subtracting the current speed of the vehicle from the safe speed bump crossing speed is less than 0, calculating the required acceleration value according to the equation:
required acceleration value=−speed difference²/(2×distance between corresponding vehicle and speed bump).

4. The method of claim 1, wherein step c) comprises:
upon determining that a speed difference obtained by subtracting the current speed of the vehicle from the safe speed bump crossing speed is greater than 0, setting a maximum acceleration value for the vehicle to a predetermined value and controlling the speed of the vehicle through acceleration or deceleration at no more than the set maximum acceleration value.

5. The method of claim 1, wherein c) further comprises:
measuring a variation in height of a rear wheel suspension of the vehicle with respect to a vertical direction of the rear wheel suspension, and upon determining that the measured height variation is greater than a preset reference height variation, determining that the corresponding vehicle has crossed the speed bump and releasing any deceleration controls imposed on the vehicle.

6. An apparatus for automatically controlling speed of a vehicle in a vicinity of a speed bump, comprising:
a speed bump information calculation unit for receiving information about a speed bump from a navigation device and calculating a distance between the vehicle and the speed bump;
a speed bump area determination unit for determining that the calculated distance between the vehicle and the speed bump is less than a preset reference distance, and upon making the determination, further determining that the corresponding vehicle is entering or has entered an area of the speed bump located within a vicinity of the speed bump;
a vehicle speed control unit for, upon determining that the vehicle is entering or has entered the speed bump area, computing a speed difference between a safe speed bump crossing speed set to allow the vehicle to safely cross the speed bump and a current speed of the vehicle, calculating a required acceleration value based on the calculated distance between the vehicle and the speed bump and on the computed speed difference, and controlling the speed of the vehicle in accordance with the calculated required acceleration value.

7. An apparatus for automatically controlling speed of a vehicle in a vicinity of a speed bump, comprising:
a control unit configured to:
receive information about a speed bump from a navigation device and calculate a distance between the vehicle and the speed bump,
upon determining that the calculated distance between the vehicle and the speed bump is less than a preset reference distance, determine that the vehicle is entering or has entered an area of the speed bump located within the vicinity of the speed bump,
upon determining that the vehicle is entering or has entered the speed bump area, compute a speed difference between a safe speed bump crossing speed set to allow the vehicle to safely drive across the speed bump and a current speed of the vehicle,
calculate a required acceleration value based on the calculated distance between the vehicle and the speed bump and on the computed speed difference, and
control the speed of the vehicle in accordance with the calculated required acceleration value.
